(19) United States
(12) Patent Application Publication
(10) Pub. No.: US 2010/0138145 A1
(43) Pub. Date: Jun. 3, 2010

(54) Helmet with voice-activated route guidance system

(75) Inventors: Kwangmoon Choi, Gyeonggi-do (KR); Jaehun Cho, Gyeonggi-do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignees: HJC Co., Ltd., Gyeonggi-do (KR); Ubitrotech Co., Ltd., Seoul (KR); UBIWISE INC., Gyeonggi-do (KR)

(21) Appl. No.: 12/315,654

(22) Filed: Dec. 5, 2008

(30) Foreign Application Priority Data
Dec. 1, 2008 (KR) 10-2008-0120469

(51) Int. Cl. G01C 21/36

(52) U.S. Cl. 701/201

(57) ABSTRACT

A helmet with a voice-activated route guidance system includes a voice receiving unit for receiving a voice signal from a helmet user; a voice recognition unit for acquiring destination information of the user by analyzing the received voice signal; a positioning unit for searching a current position of the helmet user; a route setting unit for setting a route from the current position of the helmet user to a destination; a voice signal generation unit for generating a route guidance voice signal including information for guiding the helmet user to the set route; and a sound output unit for outputting the generated route guidance voice signal.

### CROSS-REFERENCE TO RELATED APPLICATION

This application claims the benefit of Korean Patent Application No. 10-2008-0120469, filed on Dec. 1, 2008, which is hereby incorporated by reference in its entirety.

### FIELD OF THE INVENTION

The present disclosure relates to a helmet with a voice-activated route guidance system. More particularly, the present invention relates to the helmet with the voice-activated route guidance system for setting a route by using voice recognition and guiding a route by using a voice output.

### BACKGROUND OF THE INVENTION

A conventional motorcycle helmet has been provided to absorb a shock applied on a helmet user's head and protect the head from a fatal wound in an accident. However, in recent years, a motorcycle riding becomes more popular as one of leisure activities and a time for riding a motorcycle has gradually increased.

Accordingly, there has been an increasing demand for a helmet having functions of communicating with other colleague riders and playing an audio source such as an MP3 player while riding the motorcycle.

Further, as a wireless communication technology has developed, a navigation system using a GPS (Global Positioning System), i.e., a route guidance system has been widely used and such a route guidance system allows drivers to drive their vehicles with more convenience and greater safety.

However, most of conventional route guidance systems are configured to be suitable for a car which is a four-wheel-drive vehicle. That is, the conventional route guidance system which is separately installed inside the car receives a destination input through an input unit manipulatable by a user and provides audio narration and visual display of route guide information to the user while the car is running.

Therefore, the conventional route guidance system is not suitable for a motorcycle considering a structure of the motorcycle and a way of driving it, and thus it is actually impossible for a rider of the motorcycle to use the route guidance system.

Accordingly, there has been an increasing demand for a helmet having functions of communicating with other colleague riders, playing an audio source and providing information of road networks and route guidance while the motorcycle is running. To be particular, there has been a great demand for a helmet in which various functions can be selected by a simple manipulation, a destination is inputted by a voice, and route guidance information is provided in response to the destination input.

### BRIEF SUMMARY OF THE INVENTION

In view of the foregoing, an embodiment of the present invention provides a helmet with a voice-activated route guidance system capable of setting a destination by using a voice and providing a route to the set destination.

Further, another embodiment of the present invention provides a helmet equipped with a route guidance system, a communication device using a short-range wireless communication system such as a Bluetooth system for communicating with other colleague riders, and an audio source player for playing audio source data stored in an MP3 file and the like.

In order to solve the above-stated technical problems, there is provided a helmet with a voice-activated route guidance system, in which the voice-activated route guidance system includes a voice receiving unit for receiving a voice signal from a helmet user; a voice recognition unit for acquiring destination information of the user by analyzing the received voice signal; a positioning unit for searching a current position of the helmet user; a route setting unit for setting a route from the current position of the helmet user to a destination; a voice signal generation unit for generating a route guidance voice signal including information for guiding the helmet user to the set route; and a sound output unit for outputting the generated route guidance voice signal.

In accordance with an example embodiment of the present invention, the helmet may further include a casing unit, which is positioned on a side of the helmet, including the voice-activated route guidance system.

In accordance with an example embodiment of the present invention, the casing unit may include one or more control buttons for generating a signal to control the voice-activated route guidance system; a speaker for outputting the route guidance voice signal outputted from the sound output unit as sound; and a wired input/output unit for receiving a voice signal of the helmet user, wherein the control button can be positioned on an outside of the helmet and the speaker can be positioned on an inside of the helmet.

In accordance with an example embodiment of the present invention, the voice-activated route guidance system may include a communication unit for transmitting the received voice signal to an external communication terminal and for receiving a voice signal from the external communication terminal, wherein the voice signal of the external communication terminal can be outputted by the sound output unit.

In accordance with an example embodiment of the present invention, the voice-activated route guidance system may include an audio source play unit for analyzing pre-stored audio source data and converting them into a sound signal, wherein the sound signal can be outputted by the sound output unit.

### BRIEF DESCRIPTION OF THE DRAWINGS

The disclosure may best be understood by reference to the following description taken in conjunction with the following figures:

FIG. 1A is a view of a helmet equipped with a voice-activated route guidance system in accordance with an embodiment of the present invention;

FIG. 1B is another view of the helmet equipped with the voice-activated route guidance system in accordance with an embodiment of the present invention;

FIG. 2A is a view of a casing unit including the voice-activated route guidance system in accordance with an embodiment of the present invention;

FIG. 2B is another view of the casing unit including the voice-activated route guidance system in accordance with an embodiment of the present invention;

FIG. 3 is a block diagram showing a configuration of the voice-activated route guidance system in accordance with an embodiment of the present invention;

FIG. 4 is a flow chart showing a method for selecting one of functions of the voice-activated route guidance system in accordance with an embodiment of the present invention; and

FIG. 5 is a flow chart showing a route guidance method in the voice-activated route guidance system by using voice recognition in accordance with an embodiment of the present invention.

### DETAILED DESCRIPTION OF THE INVENTION

Hereinafter, embodiments of the present invention will be described in detail with reference to the accompanying drawings so that the present invention may be readily implemented by those skilled in the art. However, it is to be noted that the present invention is not limited to the embodiments but can be realized in various other ways. In the drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps., operation and/or existence or addition of elements are not excluded in addition to the described components, steps, operation and/or elements.

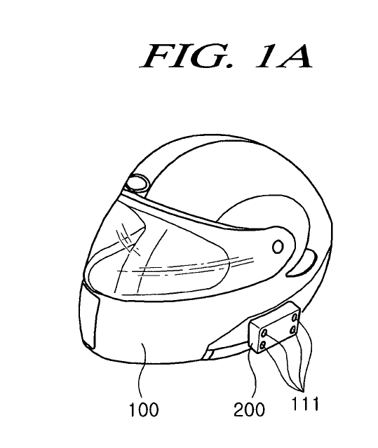

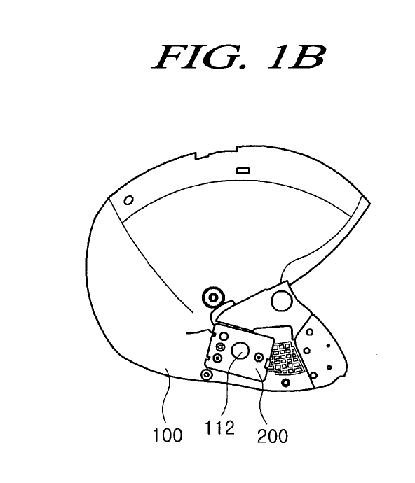

FIGS. 1A and 1B depict a view of a helmet equipped with a voice-activated route guidance system in accordance with an embodiment of the present invention.

A helmet 100 in accordance with the embodiment of the present invention includes a casing unit 110 attached to a side portion of the helmet 100. The casing unit 110 is attached to a position which does not give any inconvenience in riding a motorcycle but gives some convenience in manipulating it to a helmet user. Such a position can be determined according to a result of a wind tunnel test or the like.

The casing unit 110 includes a voice-activated route guidance system, a control button 111 for manipulating the voice-activated route guidance system and a speaker 112 for outputting a route guidance voice.

In order for the user of the helmet 100 to manipulate the control button 111 while wearing the helmet, the control button 111 is positioned on a side of the casing unit 110 exposed to the outside of the helmet 100.

Further, in order for the user of the helmet 100 to listen to the route guidance voice outputted through the speaker 112, the speaker 112 is positioned on a side of the casing unit 110 exposed to the inside of the helmet 100.

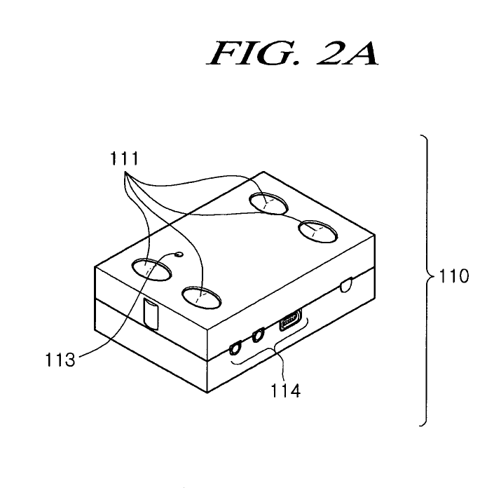

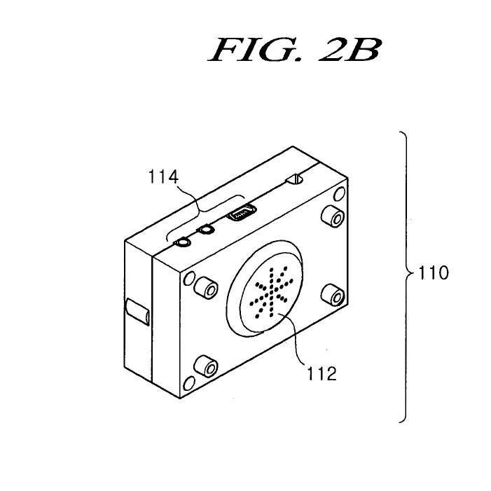

FIGS. 2A and 2B show a casing unit including the voice-activated route guidance system in accordance with an embodiment of the present invention.

The casing unit 110 in accordance with the embodiment of the present invention includes the control button 111, the speaker 112, a power display unit 113 and a wired input/output unit 114.

The control button 111 selects one of functions of the voice-activated route guidance system and generates a control signal. For example, the control button 111 may include a button for generating a signal for controlling power on/off of the voice-activated route guidance system.

Further, the control button 111 may include a button for selecting a voice-activated route guidance function and any one of other various functions of the voice-activated route guidance system, for example, a function of performing a short-range wireless communication using a Bluetooth system or plying an audio source by an MP3 player or the like.

The number of the control button 111 is not limited to four as illustrated in the drawings but can be varied if necessary.

The speaker 112 outputs the route guidance voice generated from the voice-activated route guidance system. Further, the speaker 112 can output a voice made during the short-range wireless communication or a sound made by playing the audio source.

The power display unit 113 displays power condition of the voice-activated route guidance system. For example, the power display unit 113 may display the power condition of the voice-activated route guidance system by emitting a light using a LED (Light Emitting Diode) or the like.

The wired input/output unit 114 receives and transmits a signal from and to an external device through a wired connection. For example, the wired input/output unit 114 is wired-connected to an external microphone so that it is able to receive an external voice. Further, the wired input/output unit 114 is wired-connected to an external display device so that it is able to transmit an image signal for route guidance to the external display device.

As stated above, though the casing unit 110 in accordance with the embodiment of the present invention is illustrated in FIG. 2 independently from the helmet 100 as an example, it is not limited thereto, but the helmet 100 and the casing unit 110 can be also integrally configured.

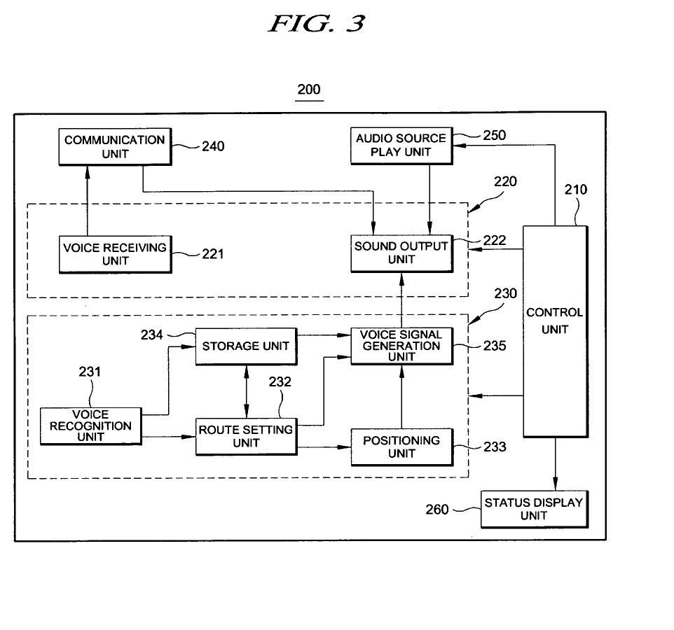

FIG. 3 is a block diagram showing a configuration of the voice-activated route guidance system in accordance with an embodiment of the present invention.

The voice-activated route guidance system 200 in accordance with the embodiment of the present invention includes a control unit 210, a signal input/output unit 220, a route guidance unit 230, a communication unit 240 and an audio source play unit 250.

The control unit 210 receives a signal from a control button unit (illustration omitted) and transmits a control signal to the signal input/output unit 220, the route guidance unit 230, the communication unit 240 or the audio source play unit 250 in response to the received signal.

That is, the control unit 210 receives a control signal for performing a function which is selected by the control button unit and transmits the control signal to configuration units to be used for the function selected according to the received signal.

For example, if the route guidance function is selected, the control unit 210 transmits the control signal to the signal input/output unit 220 and the route guidance unit 230 in order for them to generate and output a route guidance signal by receiving and recognizing the voice signal.

Further, if the function of the wireless communication is selected, the control unit 210 transmits the control signal to the signal input/output unit 220 and the communication unit 240 in order for them to transmit a voice received from the helmet user to a wireless communication target and output the voice received from the wireless communication target.

Furthermore, if the function of playing the audio source is selected, the control unit 210 transmits the control unit to the signal input/output unit 220 and the audio source play unit 250 in order for them to play and output an audio source.

Besides, the control unit 210 transmits a signal indicating a current status of the voice-activated route guidance system to a status display unit 260 in order for it to display an indication indicating the current status of the voice-activated route guidance system by the status display unit 260.

The signal input/output unit 220 includes a voice receiving unit 221 and a sound output unit 222.

The voice receiving unit 221 receives a voice signal of the helmet user through a microphone or the like. The voice receiving unit 221 transmits the received voice signal to a voice recognition unit 231 or the communication unit 240.

The voice receiving unit 221 receives the voice signal by using a dual microphone capable of separating a voice signal captured by one microphone from a background noise captured by the other one so as to remove a noise and providing a clear voice signal only.

That is, if the control signal for the route guidance is received from the control unit 210, the voice receiving unit 221 transmits the received voice signal to the voice recognition unit 231. Further, if the control signal for the wireless communication is received from the control unit 210, the voice receiving unit 221 transmits the received voice signal to the communication unit 240.

The sound output unit 222 receives a sound-related signal from a voice signal generation unit 235, the communication unit 240 or the audio source play unit 250 and outputs the received signal.

For example, the sound output unit 222 may output a route guidance voice signal received from the voice signal generation unit 235, or output an audio source play signal received form the audio source play unit 250. Further, the sound output unit 222 may output a voice signal of the wireless communication target received from the communication unit 240.

The route guidance unit 230 includes the voice recognition unit 231, a route setting unit 232, a positioning unit 233, a storage unit 234 and the voice signal generation unit 235.

The voice recognition unit 231 receives a voice signal of the helmet user from the voice receiving unit 221 and removes a noise signal included in the received voice signal. The voice signal of the helmet user may include various kinds of noises made while a motorcycle is running. Therefore, for an accurate analysis of the voice signal, the voice recognition unit 231 removes the noise included in the voice signal.

The voice recognition unit 231 presets a frequency range which is highly likely to correspond to a noise, for example, a frequency range corresponding to a wind sound and can remove the noise by removing the preset frequency range from the voice signal received from the voice receiving unit 221.

The voice recognition unit 231 obtains destination information included in the voice signal by analyzing the voice signal from which the noise signal is removed, and transmits the obtained destination information to the route setting unit 232 and the storage unit 234. That is, the voice recognition unit 231 recognizes a voice from the voice signal in which the noise signal is removed, and transmits the destination information obtained from the recognized voice to the route setting unit 232 and the storage unit 234.

A voice recognition is a procedure for identifying a word or a word sequence from a received voice signal, i.e., a voice wave and extracting a meaning thereof. The procedure can be roughly divided into five steps such as analyzing a voice, recognizing a phoneme, recognizing a word, analyzing a sentence and extracting a meaning. Also, in a narrow sense, the voice recognition usually indicates a procedure covering from a step of analyzing a voice to a step of recognizing a word.

There has been developed various software engines for the voice recognition and a voice recognition engine used in the voice recognition unit 231 is not limited to any specific one and any engine capable of recognizing the voice can be used.

In particular, the voice recognition unit 231 recognizes a voice through not only recognition of a word, i.e., an isolated word but also recognition of a continuous voice, thereby obtaining destination information. Further, the voice recognition unit 231 implements a speaker dependent voice recognition process by which only a registered voice can be recognized as well as a speaker independent voice recognition process by which a voice can be recognized regardless of whether or not it has been registered, thereby recognizing a voice.

The route setting unit 232 receives the destination information for the route guidance from the voice recognition unit 231 and receives information of a current position from the positioning unit 233. Further, the route setting unit 232 receives map data from the storage unit 234, sets a route from the current position to the destination by using the received map data, and generates route data.

The route setting unit 232 is able to set various routes depending on a given condition. For example, according to a preset condition, it is possible to set a route having a shortest distance or set a route including a specific stop position.

Further, if the current position received from the positioning unit 233 is not placed on the set route, the route setting unit 232 resets a route to the destination and generates route data of the reset route.

The route setting unit 232 transmits the generated route data to the storage unit 234 and the voice signal generation unit 235.

The positioning unit 233 identifies the current position of the voice-activated route guidance system and transmits information of the identified current position to the route setting unit 232, the storage unit 234 and the voice signal generation unit 235.

The positioning unit 233 searches the current position of the helmet user by using, a global positioning system (GPS).

The storage unit 234 stores the map data for the route setting and the route guidance, and stores the destination information, the route data, the information of the current position, or the like received from the voice recognition unit 231, the route setting unit 232 and the positioning unit 233. Further, the storage unit 234 may store a preset condition for the route guidance such as the shortest distance, the specific stop position or the like. The map data stored in the storage unit 234 may include road information of each local.

The voice signal generation unit 235 generates a voice signal for the route guidance by using the route data received from the route setting unit 235, the destination information received from the storage unit 234 and the information of the current position received from the positioning unit 233.

The voice signal generation unit 235 generates a voice signal by using a text-to-speech (TTS) technology. That is, the voice signal generation unit 235 generates text data for the route guidance by using the destination information and the information of the current position, converts the generated text data into voice data, thereby generating the voice signal including the converted voice data.

Unlike the above-stated case, even though the voice-activated route guidance function is selected by the control unit 210, if the voice signal is not received by the voice receiving unit 221 or the destination information is not obtained through the voice recognition and analysis of the voice recognition unit 231, the voice signal generation unit 235 generates a voice signal for the information on the current position by using the information of the current position received from the positioning unit 233 and the map data received from the storage unit 234.

The voice signal generation unit 235 transmits the generated voice signal to the sound output unit 222.

The communication unit 240 performs a wireless communication with an external communication device (illustration omitted). The communication unit 240 receives and transmits a communication signal, e.g., a voice signal from and to the preset external communication device in response to the control signal received from the control unit 210.

That is, the communication unit 240 receives the voice signal from the external communication device and transmits the received voice signal to the sound output unit 222. Further, the communication unit 240 receives the voice signal from the voice receiving unit 221 and transmits it to the external communication device.

For example, the communication unit 240 can receive and transmit the voice signal from and to the external communication device by using the Bluetooth system.

The audio source play unit 250 analyzes pre-stored audio source data, converts them into a sound signal, and transmits the converted sound signal to the sound output unit 222 in response to the control signal received from the control unit 210.

The audio source data can be stored in an internal or external storage device and may include files having file extensions such as “.mp3”, “.wav” or the like.

The status display unit 260 receives information of a current status of the voice-activated route guidance system from the control unit 210 and generates a status information signal including the received status information of the system. The status display unit 260 outputs the generated status information signal to an internal or external display device, thereby displaying the system status such as power ON/OFF condition of the system, information of the selected function of the system, or the like.

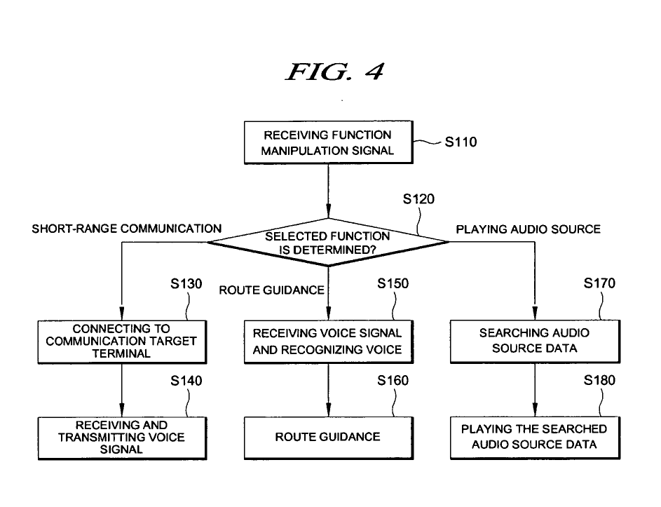

FIG. 4 is a flow chart showing a method for selecting one of functions of a voice-activated route guidance system in accordance with an embodiment of the present invention.

In step S110, a function manipulation signal inputted by a helmet user through a control button is received. The received function manipulation signal may include a manipulation signal for selecting a function such as a short-range communication, route guidance or an audio source play.

In step S120, a type of the selected function is determined by analyzing the received function manipulation signal. As stated above, the function manipulation signal may include a manipulation signal for a function such as the short-range communication, the route guidance or the audio source play. Therefore, it is determined whether any one of the functions of the short-range communication, the route guidance and the audio source play is selected.

In step S130, if it is determined that the function of the short-range communication is selected according to the function manipulation signal in step S120, the system connected to a communication target terminal by using a short-range wireless communication system such as the Bluetooth system. The function manipulation signal received during step S110 may include information of the communication target terminal and the communication target terminal can be set by using such information or can be preset.

In step S140, the voice signal received from the helmet user is transmitted to the communication target terminal connected through the short-range wireless communication in step S130 and a voice signal is received from the communication target terminal. The voice signal of the helmet user can be generated by a microphone or the like installed in the helmet and the voice signal received from the communication target terminal can be outputted through a speaker or the like.

In step S150, if it is determined that the route guidance function is selected according to the function manipulation signal, a voice signal is received from the helmet user and destination information is obtained by recognizing the received voice signal.

In step S1160, information of a current position is obtained and route guidance is performed by using the obtained information of the current position and destination information obtained during step S150. That is, it is possible to perform the route guidance by generating the voice signal including the information of the route from the current position to the destination and outputting the generated voice signal through the speaker or the like.

In step S170, if it is determined that the audio play function is selected according to the function manipulation signal in step S120, audio source data, i.e., files having file extensions such as “.mp3”, “.wav” or the like are searched. The audio source data can be pre-stored in the voice-activated route guidance system by the helmet user and audio source data to be played among a great deal of the audio source data can be preset.

In step S180, the audio source data searched during step S170 is played and outputted through the speaker or the like. The function manipulation signal received in step S110 may include information on a play mode of the audio source data such as repeat play, random play and the like, or information of a volume or the like. Therefore, the searched audio source data is played according to the play mode included in the function manipulation signal.

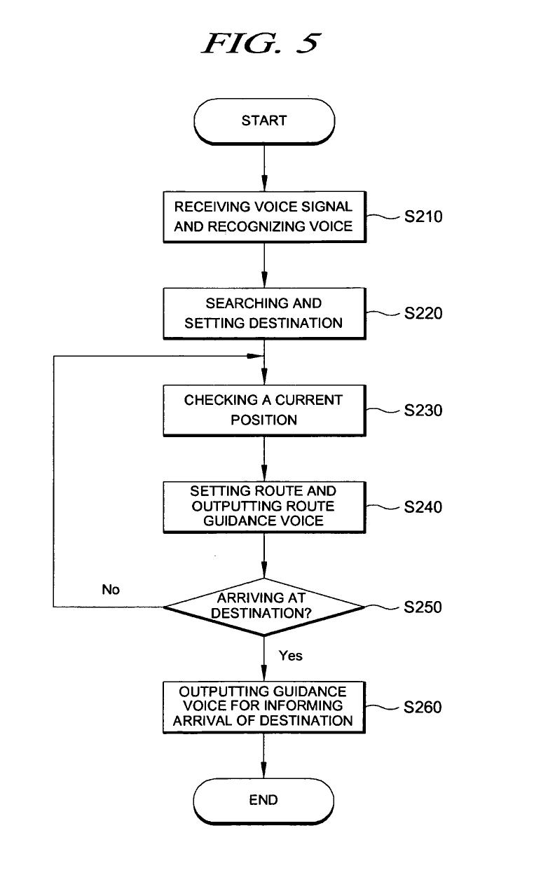

FIG. 5 is a flow chart showing a route guidance method in a voice-activated route guidance system by using voice recognition in accordance with an embodiment of the present invention.

In step S210, the voice-activated route guidance system receives a voice signal from a helmet user through a microphone or the like. The voice signal received from the helmet user may include the helmet user's voice and a external noise. In particular, a voice signal can be generated while the motorcycle is running, and the noise signal made while the motorcycle is running may be included in the voice signal.

Accordingly, the voice-activated route guidance system removes the external noise from the received voice signal. Further, the voice-activated route guidance system recognizes information included in the voice signal by analyzing the voice signal from which the noise signal is removed, and obtains destination information from the recognized information.

In step S220, a position corresponding to the destination information obtained during step S210 is searched by using pre-stored map data, and the searched position is determined as a destination of the route.

In step S230, the voice-activated route guidance system checks a current position of the helmet user by using a global positioning system (GPS) or the like.

In step S240, a route from the current position checked in step S230 to the destination determined in step S220 is set. If there is any preset condition for route setting, the route is set according to such a condition. The condition for route setting may be a condition that the route should include, e.g., a specific position or a specific course.

The voice-activated route guidance system generates a voice signal for guidance of a set route and outputs the generated voice signal through an output device such as a speaker or the like. The route guidance voice signal may include information of an area where the helmet user is located, e.g., a speed limit and the like as well as information for route guidance.

In step S250, it is determined whether or not the helmet user arrives at the destination by checking the current position of the helmet user and comparing the checked position with the destination. If the helmet user is located within a preset distance from the destination, it is determined that the helmet user arrives at the destination.

In step S260, if it is determined in step S250 that the helmet user arrives at the destination, the voice-activated route guidance system generates a voice signal informing the helmet user of arriving at the destination, and outputs the generated voice signal.

The route guidance method in accordance with the above-stated embodiment of the present invention was a method of guiding a route toward a destination. However, if the destination is not determined by the voice signal, the voice-activated route guidance system checks a current position of the helmet user, and generates and outputs a voice signal including information on the checked position such as a speed limit and the like. Through the voice guidance, the helmet user can receive information for riding of a motorcycle or the like is running even if the destination is not set separately.

In accordance with a means for solving the problems, it is possible to provide a helmet with a route guidance system for setting a destination by recognizing a helmet user's voice and providing route guidance by using a voice signal.

Further, in accordance with a means for solving the problems, a casing unit including a voice-activated route guidance system is positioned on a side of the helmet and a control button of the casing unit is positioned on an outside of the helmet so that it is possible for a helmet user to easily manipulate the voice-activated route guidance system. Further, a speaker of the casing unit is positioned on an inside of the helmet so that it is possible for the helmet user to clearly identify the route guidance voice even if the motorcycle is running.

Furthermore, in accordance with a means for solving the problems, it is possible for the helmet user to make a voice communication with other colleague riders in a short distance by using an installed communication device, or play and listen to an audio source by using an audio source play device while the motorcycle is running.

The above description of the present invention is provided for the purpose of illustration, and it would be understood by those skilled in the art that various changes and modifications may be made without changing technical conception and essential features of the present invention. Thus, it is clear that the above-described embodiments are illustrative in all aspects and do not limit the present invention.

The scope of the present invention is defined by the following claims rather than by the detailed description of the embodiment. It shall be understood that all modifications and embodiments conceived from the meaning and scope of the claims and their equivalents are included in the scope of the present invention.

What is claimed is:

1. A helmet with a voice-activated route guidance system, in which the voice-activated route guidance system includes:
a voice receiving unit for receiving a voice signal from a helmet user;
a voice recognition unit for acquiring destination information of the user by analyzing the received voice signal;
a positioning unit for searching a current position of the helmet user;
a route setting unit for setting a route from the current position of the helmet user to a destination;
a voice signal generation unit for generating a route guidance voice signal including information for guiding the helmet user to the set route; and
a sound output unit for outputting the generated route guidance voice signal.

2. The helmet of claim 1, wherein the voice-activated route guidance system further includes a status display unit for generating and displaying information on functions performed by the voice-activated route guidance system.

3. The helmet of claim 1, wherein the positioning unit searches the current position of the helmet user by using a global positioning system (GPS).

4. The helmet of claim 1, wherein the voice receiving unit receives the voice signal through a dual microphone.

5. The helmet of claim 1, wherein the voice recognition unit recognizes a continuous voice included in the received voice signal and analyzes the received voice signal.

6. The helmet of claim 1, wherein the voice recognition unit analyzes the voice signal by using at least one of a speaker dependent voice recognition process and a speaker independent voice recognition process.

7. The helmet of claim 1, wherein the voice signal generation unit generates the route guidance voice signal by using a text-to-speech (TTS) technology.

8. The helmet of claim 1 further comprising:
a casing unit, which is positioned on a side of the helmet, including the voice-activated route guidance system.

9. The helmet of claim 8, wherein the casing unit includes:
one or more control buttons for generating a signal to control the voice-activated route guidance system;
a speaker for outputting the route guidance voice signal outputted from the sound output unit as sound; and
a wired input/output unit for receiving a voice signal of the helmet user,
wherein the control button is positioned on an outside of the helmet and the speaker is positioned on an inside of the helmet.

10. The helmet of claim 9, wherein the control button includes a button for selecting at least one of a voice-activated route guidance function, a short-range wireless communication function, and an audio source plying function.

11. The helmet of claim 1, wherein if the voice signal is not received from the helmet user, the voice signal generation unit generates a route guidance voice signal including information on the current position.

12. The helmet of claim 1, wherein the voice-activated route guidance system includes:
a communication unit for transmitting the received voice signal to an external communication terminal and for receiving a voice signal from the external communication terminal,
wherein the voice signal of the external communication terminal is outputted by the sound output unit.

13. The helmet of claim 12, wherein the communication unit receives and transmits the voice signal from and to the external communication terminal by using a Bluetooth system.

14. The helmet of claim 1, wherein the voice-activated route guidance system includes:
an audio source play unit for analyzing pre-stored audio source data and converting them into a sound signal,
wherein the sound signal is outputted by the sound output unit.
